(19) United States
(12) Patent Application Publication
(10) Pub. No.: US 2009/0045221 A1
(43) Pub. Date: Feb. 19, 2009

(54) Touchless optically controlled dispenser

(76) Inventors: Heiner Ophardt, Vineland (CA); Andrew Jones, Smithville (CA)

Correspondence Address: RICHES, MCKENZIE & HERBERT, LLP, SUITE 1800, 2 BLOOR STREET EAST, TORONTO, ON, M4W 3J5, CA

(21) Appl. No.: 11/983,065

(22) Filed: Nov. 8, 2007

(30) Foreign Application Priority Data
Aug. 13, 2007 (CA) 2,597,190

(51) Int. Cl. B67D 5/08; B67D 5/06; G01F 11/00

(52) U.S. Cl. 222/52; 222/372; 222/181.3; 222/325

(57) ABSTRACT

An automatically controlled apparatus whose operation is controlled at least in part by the input of a signal that an object is sensed in a selected positioned relative the apparatus, the apparatus having an emitter to emit electromagnetic radiation and a sensor to sense electromagnetic radiation emitted by the emitter which is reflected off an object suitably positioned relative the apparatus, the improvement comprising a carriage member mounted to the apparatus for relative pivoting about a pivot axis, the emitter and sensor carried by carriage member, the emitter being generally directional emitting radiation to emanate outwardly from the emitter generally along a longitudinal emission axis, the sensor being generally directional and sensing radiation which emanates generally along a longitudinal sensing axis terminating in the sensor, the emission axis and the sensing axis generally disposed in a common plane which includes the horizontal axis.

### SCOPE OF THE INVENTION

This invention relates to an optically controlled dispensing mechanism and, more particularly, to a dispenser whose operation is controlled by optical sensors which can be moved to assume different sensing positions.

### BACKGROUND OF THE INVENTION

Touchless dispensers are known in which a dispenser operates by sensing the presence of a user's hand below a discharge outlet. As one such touchless system, it is known to provide an emitter which emits electromagnetic radiation and a sensor adapted to sense electromagnetic radiation emitted by the sensor which has been reflected off the hand of a user disposed below the discharge outlet. Dispensing occurs when light reflected from the hand of a user under the discharge outlet is received by the sensor. In the absence of a hand disposed under the discharge outlet dispensing is not desired to occur.

Typical known soap dispensers have their hand sensing systems including the sensor and emitter disposed to be fixed relative to the dispenser to dispense when the hand is located at a desired position underneath the dispenser.

The present inventors have appreciated that disadvantages arise when sensors are placed, for example, above reflective tabletops or sinks in that reflection of electromagnetic radiation from the sensor off the countertop or sink can reach the sensor causing false activations. The present inventors have appreciated that with many soap dispensers in which the hand sensing systems direct the electromagnetic radiation virtually vertically downwardly, it can be difficult to locate a dispenser at a sufficient height above a countertop or sink to avoid false activations.

### SUMMARY OF THE INVENTION

To at least partially overcome these disadvantages and difficulties of the previously known devices, the present invention provides a touchless dispenser in which a hand sensing system, preferably including a sensor and an emitter to receive radiation from the emitter reflected off a hand of a user, is adjustable to permit the sensor and emitter to be disposed at different orientations relative to the dispenser.

An object of the present invention is to provide a touchless dispenser which permits easy adjustment of the direction that the sensor and emitter of a hand sensing system are directed relative to the remainder of the dispenser.

In one aspect, the present invention provides an automatically controlled apparatus whose operation is controlled at least in part by the input of a signal that an object is sensed in a selected positioned relative the apparatus, the apparatus having an emitter to emit electromagnetic radiation and a sensor to sense electromagnetic radiation emitted by the emitter which is reflected off an object suitably positioned relative the apparatus, the improvement comprising a carriage member mounted to the apparatus for relative pivoting about a pivot axis,

the emitter and sensor carried by carriage member,

the emitter being generally directional emitting radiation to emanate outwardly from the emitter generally along a longitudinal emission axis,

the sensor being generally directional and sensing radiation which emanates generally along a longitudinal sensing axis terminating in the sensor,

the emission axis and the sensing axis generally disposed in a common plane which includes the horizontal axis. Preferably, the apparatus is an automatic dispensing apparatus for dispensing material onto the hand of a user when positioned under a dispensing outlet for the material to be dispensed.

### BRIEF DESCRIPTION OF THE DRAWINGS

Further aspects and advantages of the present invention will be come apparent from the following description taken together with the accompanying drawings in which:

FIG. 1 is a pictorial view of a dispenser assembly in accordance with a first preferred embodiment of the present invention;

FIG. 2 is a pictorial exploded view of the dispenser assembly shown in FIG. 1;

FIG. 3 is a pictorial view showing assembly of the reservoir assembly and backplate assembly shown in FIG. 2;

FIG. 4 is a schematic pictorial side view showing the relative positioning of a user's hand relative the reservoir assembly and an activation unit of the dispenser of FIGS. 1 and 3;

FIG. 5 is an exploded pictorial view of the reservoir assembly shown in FIGS. 2 and 3;

FIG. 6 is a pictorial view showing the assembled bottle, valve member, piston chamber forming member and piston shown in FIG. 5;

FIG. 7 is a pictorial top rear view of the collar shown in FIG. 5;

FIG. 8 is a schematic cross-sectional side view of the dispenser assembly 10 shown in FIG. 1;

FIG. 9 is an exploded pictorial front view of the backplate assembly shown in FIG. 2;

FIG. 10 is a rear pictorial view of the activation unit shown in FIG. 9;

FIG. 11 is a schematic exploded pictorial front view of the activation unit shown in FIG. 9;

FIG. 12 is a schematic exploded pictorial bottom view of selected components of the activation unit shown in FIG. 10;

FIG. 13 is an exploded pictorial rear view of the top and bottom elements of the carriage member shown in FIG. 12;

FIG. 14 is a schematic pictorial assembled view of the circuit board and carriage member shown in FIG. 11; and

FIG. 15 is a schematic side view of FIG. 4.

### DETAILED DESCRIPTION OF THE DRAWINGS

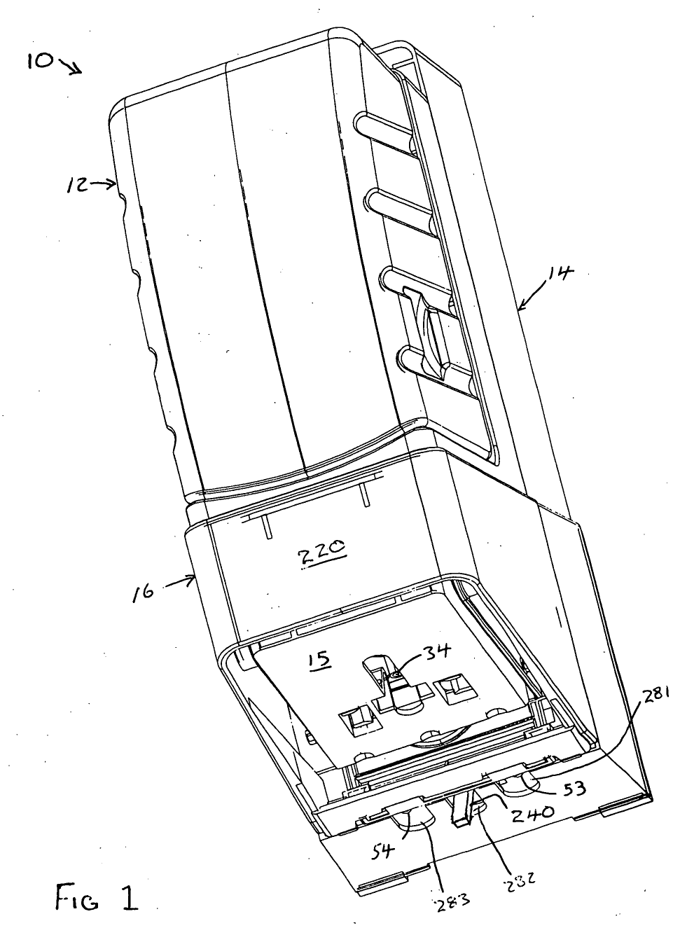

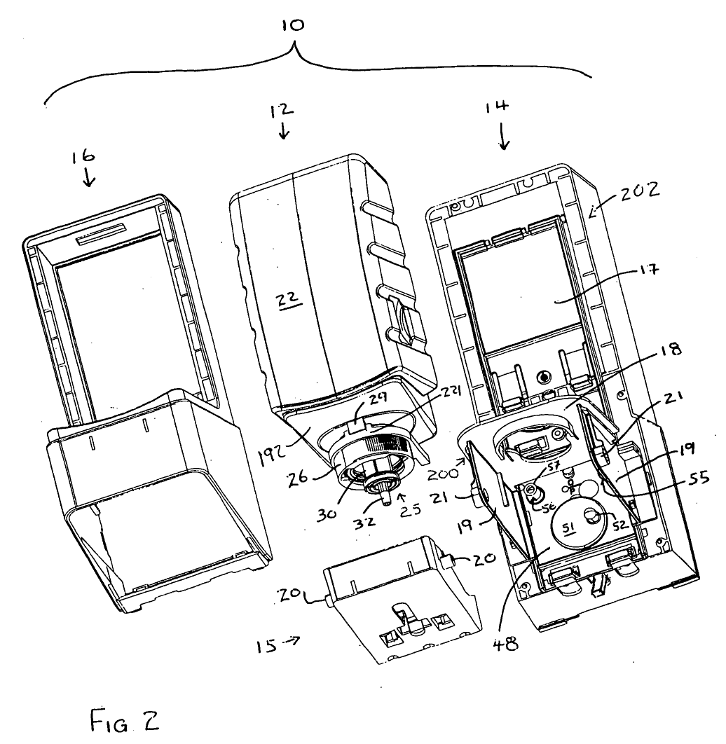

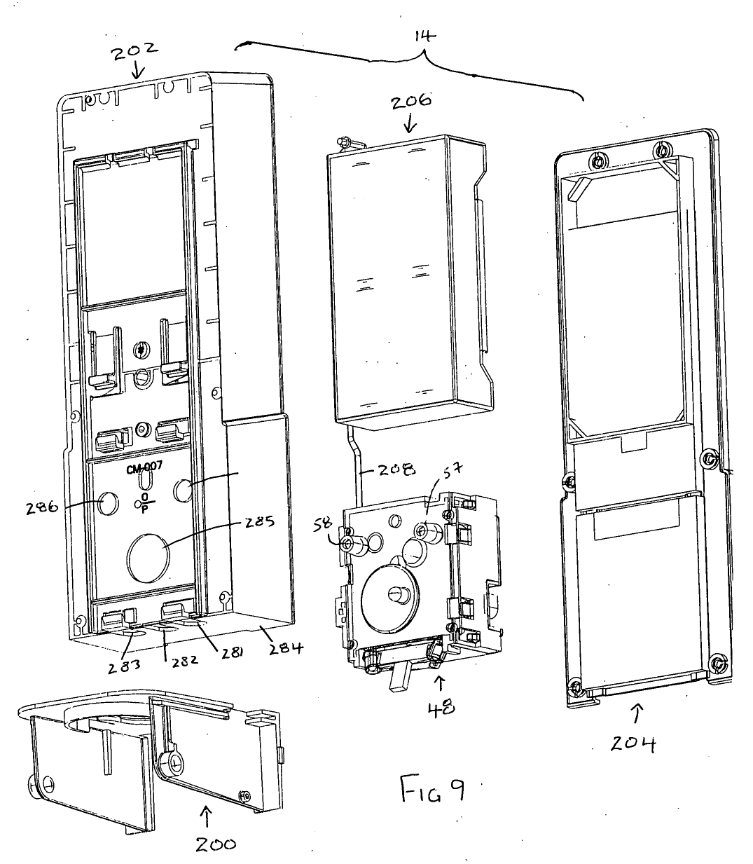

Reference is made to FIG. 1 which illustrates a dispenser assembly 10 in accordance with a first preferred embodiment of the present invention. The dispenser assembly 10, as best seen in FIG. 2, includes a removable reservoir assembly 12 adapted to be secured to a housing formed by a combination of a backplate assembly 14, a presser member 15 and a shroud 16. As seen in FIG. 9, the backplate assembly 14 includes a reservoir support bridge 200, a backplate front housing 202, a backplate rear housing plate 204, a battery pack 206 and an activation unit 48. The battery pack 206 and the activation unit 48 are received inside an enclosed compartment formed between the assembled backplate front housing 202 and backplate rear housing plate 204. An electrical wire 208 electrically connects batteries in the battery pack 206 with electronic/electric components in the activation unit 48.

Referring to FIG. 2, the reservoir support bridge 200 is supported on a generally forwardly directed face plate 17 of the backplate front housing 202 from which a horizontally disposed support plate 18 of the support bridge 200 extends forwardly supported by two side plates 19. The presser member 15 is pivotally mounted to the support bridge 200 between the two side plates 19 with stub axles 20 received in journaling bores 21 in each of the side plates 19. The housing is completed by the shroud 16 being coupled to the backplate assembly 14 to substantially enclose the support bridge 200 and the presser member 15. The reservoir assembly 12 is adapted to removably couple to the assembled housing with a piston 32 of a pump assembly 25 of the reservoir assembly 12 becoming coupled to the presser member 15.

### Activation Unit

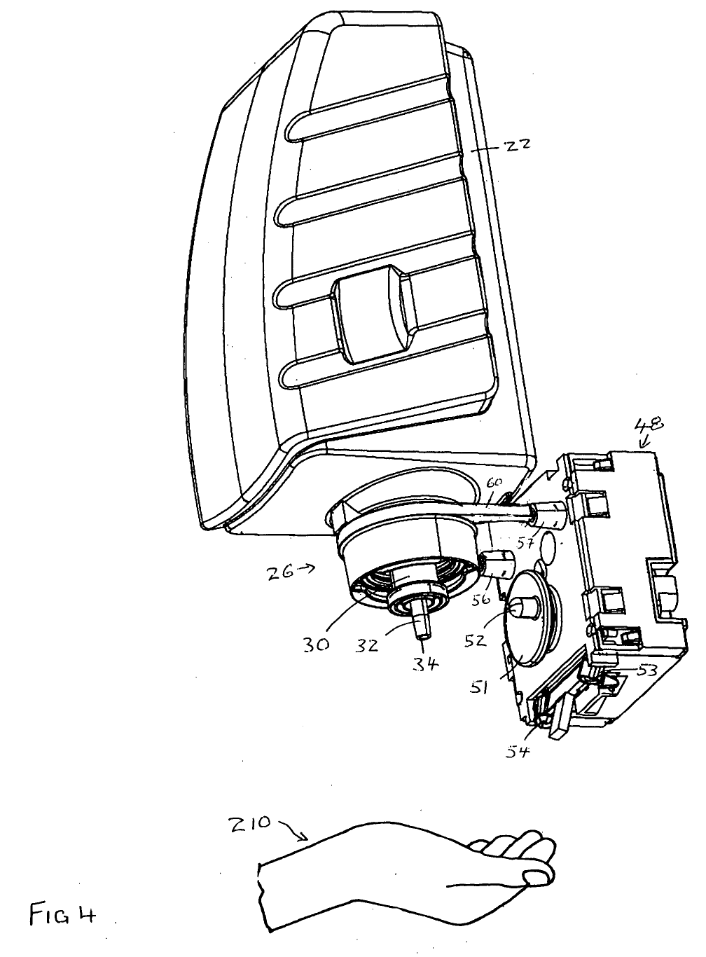

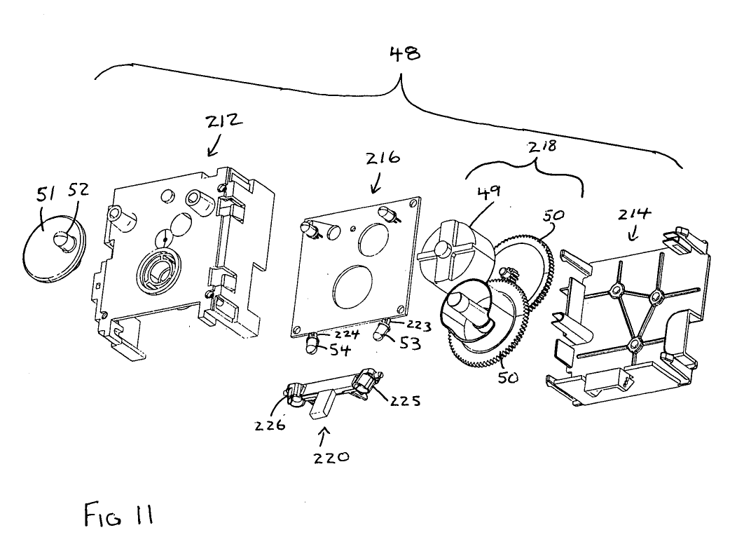

The backplate assembly 14 includes and carries the activation unit 48 best seen in FIGS. 4, 9 to 12 and 15. The activation unit 48 includes as schematically shown in FIG. 11, an internal drive assembly including an electric motor 49 which rotates via a series of gears 50, a drive wheel 51 carrying an eccentrically mounted axially extending externally mounted cam post 52. The cam post 52 couples to an inner end of the presser member 15 such that in rotation of the drive wheel 51 in one full revolution, the presser member 15 is pivoted about its stub axles 20 downwardly and then upwardly, returning to the same position. The presser member 15 is coupled to piston 32 of the pump assembly 25 of the reservoir assembly 12.

In one cycle of operation, the motor 49 is operated so as to rotate the drive wheel 51 360 degrees and thus move the presser member 15 and hence the piston 32 in a single stroke inwardly and outwardly to dispense an allotment of fluid from the bottle 22 of the reservoir assembly out a discharge outlet 34 of the piston 32. The motor 49 is an electric motor and its operation may be controlled by a control mechanism receiving various inputs.

The activation unit 48 shown is adapted provide touchless operation of the dispenser in a manner in which, as seen in FIG. 4, the presence of a user's hand 210 underneath the discharge outlet 34 is sensed by a hand sensing system. The hand sensing system includes an electromagnetic radiation emitter 53 located at the bottom front of the activator unit 48 to direct radiation downwardly and forwardly towards the position the user's hand 210 is to be placed and an electromagnetic radiation sensor 54 also located at the bottom front of the activator unit 48 to sense radiation reflected off the user's hand 210. The hand sensing system, on suitable receipt of reflected radiation from the hand, provides a suitable signal to the control mechanism indicating the presence of the hand, for example, satisfying at least one condition for operation of the motor.

The activation unit 48 is schematically shown in a pictorial exploded view in FIG. 11 as having a lid 212 which mates with a base 214 to provide a substantially enclosed internal compartment therebetween for mounting of a circuit board 216 and the internal drive assembly 218 as well as a carriage member 220. The motor 49 is adapted to be mounted to the circuit board 216 electrically coupled thereto. The various gears 50 are journalled at each of their ends to the lid 212 and the base 214 with suitable openings provided through the circuit board and permitting, for example, coupling of one of the gears 50 through the lid 212 to carry and rotate the drive wheel 51. The circuit board 216 carries the emitter 53 and sensor 54 of the hand sensing system electrically coupled thereto by flexible wiring 223 and 224. The carriage member 220 carries two generally cylindrical sockets 225 and 226 to securely receive, respectively, the emitter 53 and the sensor 54 secured therein coaxially within one of the sockets 225 and 226 of the carriage member 220.

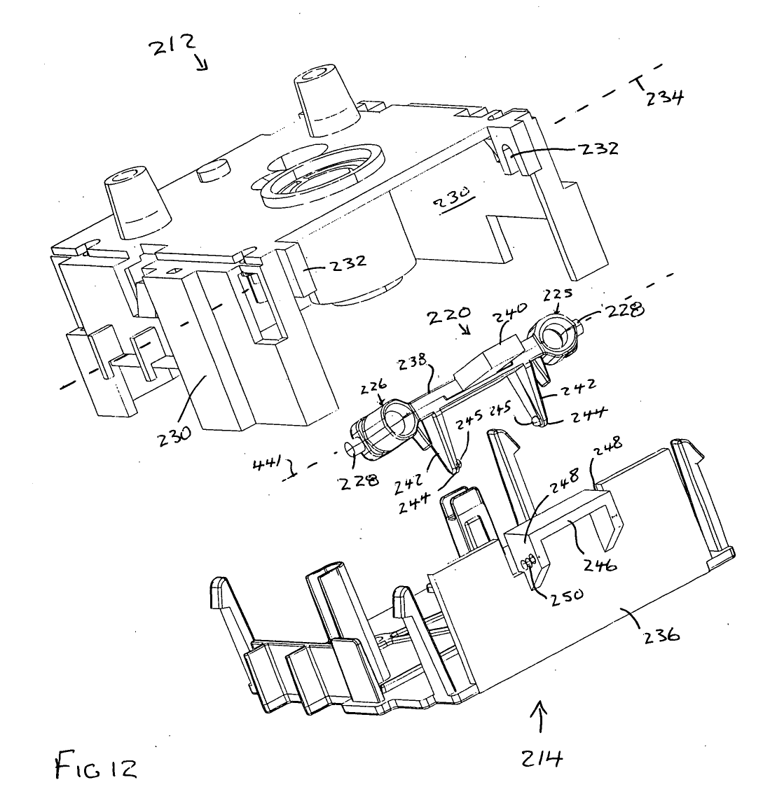

As best seen in FIG. 12, the assembled carriage member 220 has a pair of stub axles 228, one at each end, coaxially disposed and providing cylindrical outwardly directed journaling surfaces. The lid 212 has side walls 230 which carry inwardly directed sockets 232 within which the stub axles 228 of the carriage member are to be received such that the carriage member becomes journalled to the lid 212 for pivoting about a general axis indicated as 234. The stub axles 228 are held in the sockets 232 against removal by portions of a front wall 236 of the base 214 closing the open ends of the sockets 232 when the lid 212 and base 214 are secured together.

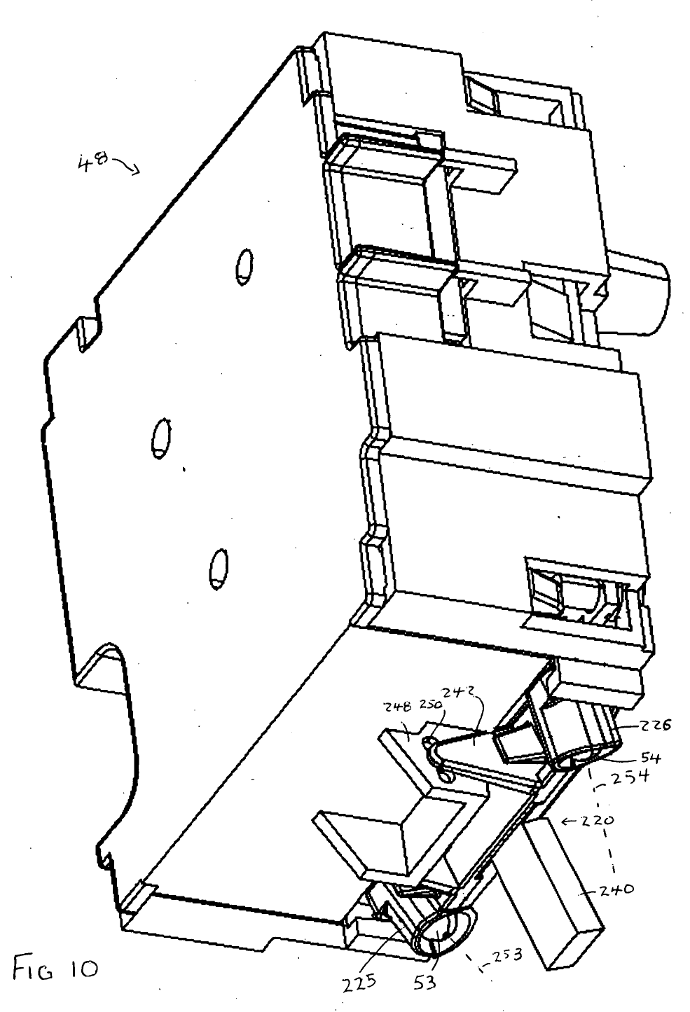

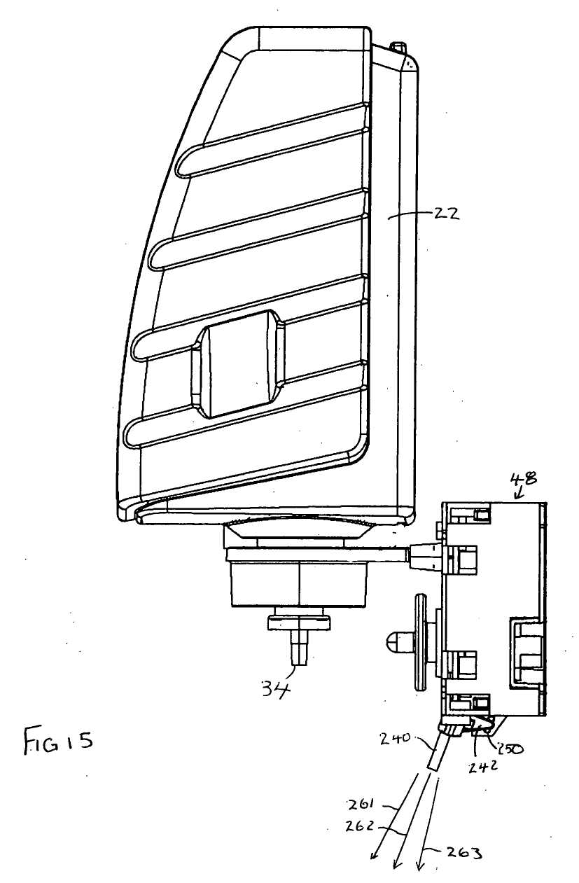

The carriage member 220 has a support bar 238 extending parallel to the stub axles 228 and coupling the sockets 225 and 226 fixedly together. A removable handle member 240 is shown coupled to the carriage member 220 extending forwardly from the support bar 238 centered between the two sockets and extending radially relative to an axis 441 through the stub axles 228. A pair of catch arms 242 extend radially from the support bar 238 spaced from each other on either side of the handle member 240, however, at a different angle relative to the axis 441 of the stub axles 228 than the handle member 240. Each of the catch arms 242 extends from an inner end where it is coupled to the support bar 238 to a distal end 244. Each catch arm 242 carries an inwardly extending semi-spherical boss 245 proximate its end 244. The front wall 236 of the base 214 carries a locating bridge 246 with a pair of side surfaces 248 each of which has an array of semi-circular recesses 250 disposed at different locations in an arc about the pivot axis 234 when the lid 212 is coupled to the base 214. In an assembled actuation unit 48 as shown in FIG. 10, with the carriage member 220 journalled in the sockets 232 for pivoting about the pivot axis 234, the catch arms 242 are disposed outwardly of each of the side surfaces 248 of the locating bridge 246 with the bosses 245 adapted to be received in any one of the recesses 250 so as to locate the carriage member 220 at one of a number of different rotational positions about the axis 234. In FIGS. 10 and 15, the array of recesses 250 is shown to include three recesses and the carriage member 220 is shown as being located in an intermediate of the recesses 250.

As seen in FIG. 1, the removable handle 240 when coupled to the carriage member 22 extends forwardly and is adapted to manually be grasped by an installer's hand and forcibly urged to move the bosses 245 out of one pair of the recesses 250 into another pair.

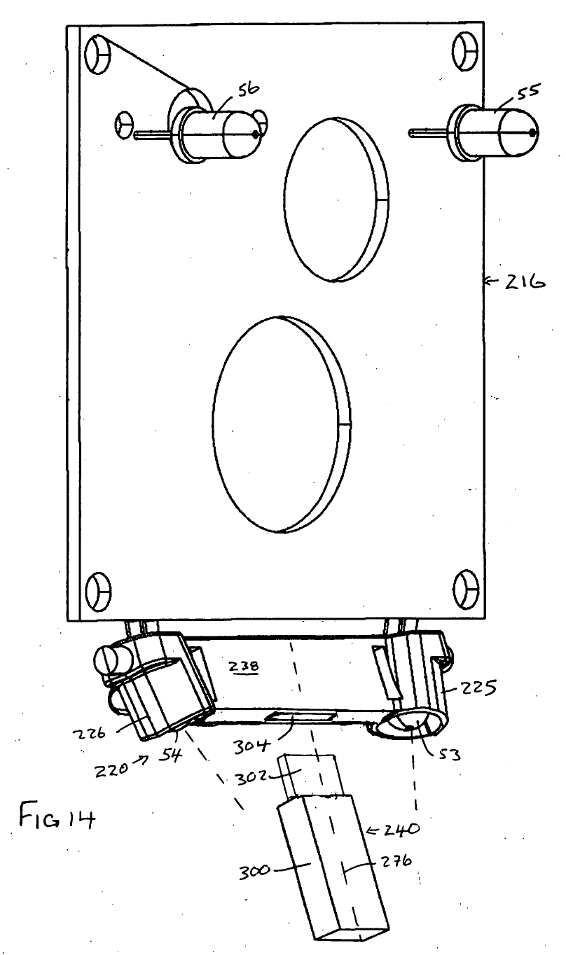

The emitter 53 comprises a lamp which is generally configured so as to be generally directional, that is, to direct electromagnetic radiation to emanate outwardly from the emitter generally along a longitudinal emitter axis 253 and, similarly, the sensor is generally directional so as to sense radiation which emanates generally along a longitudinal sensor axis 254 terminating in the sensor as seen in FIG. 14. Each of the sockets 255 and 256 effectively act as a shroud which assists in substantially preventing any transmission of electromagnetic radiation therethrough and effectively serves to assist in directionalizing the emitter 53 and the sensor 54 so as to restrict emissions or reception of either to radiation passing through the outer ends of the sockets 225 and 226. The emitter axis 253 and the sensor axis 254 are disposed in a common plane which includes the pivot axis 234 about which the carriage member 220 is journalled to the activation unit 48. Similarly, the handle 240 is shown as extending substantially in the same plane. The emitter axis 253 and sensor axis 254 are angled relative to each other so as to converge in the plane including the pivot axis 234 a convergent point at a fixed distance from the pivot axis 234. With these emitter axis 253 and sensor axis 254 each disposed at the same relative angle to the pivot axis 234, the convergent point is located centered between the sockets 225 and 226 as preferred for symmetrical location and arrangement on the dispenser although this is not necessary.

Referring to FIG. 15, there is illustrated by an arrow 262 in side view, the common plane containing each of the emitter axis 253 and the sensor axis 254 when the catch arms 242 are secured with their bosses in the intermediate recess 250. Arrows 261 and 263 show the position of this common plane if the carriage member 220 is rotated to have the catch arms 242 engaged in the lowermost and uppermost recesses 250, respectively.

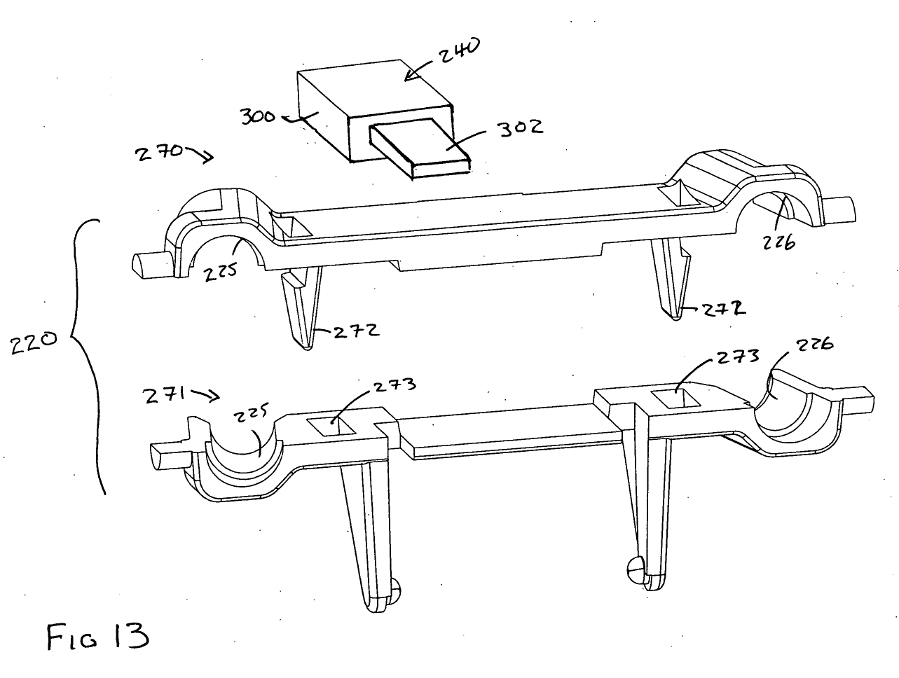

Reference is made to FIG. 13 which shows the carriage member 220 as being formed from a top element 270 and a bottom element 271 which are adapted to snap-fit together as with catches 272 on the top element 270 to pass through and snap-fit into openings 273 in the bottom element 271. The top element 270 carries half of the stub axle 222 while the bottom 271 carries the other half. Similarly, the top element 270 carries a top half of the socket 225 and the top half of the socket 226 and the bottom element 271 carries a bottom half of the socket 225 and a bottom half of the socket 226. On snap-fitting the top 270 to the bottom 271, the emitter 53 is received coaxially within the socket 225 against removal and the sensor 54 is received coaxially within the socket 226 against removal.

By positioning the carriage member 220 to assume any one of the upper, intermediate, or lower positions indicated by the arrows 261, 262 and 263 in FIG. 15, the ability of hand sensing system to avoid undesired reflection off a permanent object such as a countertop located underneath the discharge outlet 34 will vary. As well, there may be a preferred location and distance below the dispensing outlet 34 for a hand to be placed and sensed, for example, as shown in FIG. 15 as with the carriage member in the intermediate position represented by arrow 262. However, in certain environments, for example, due to the presence of a countertop below the dispenser which restricts the ability of a hand to be located in positions above the countertop, may render it advantageous for the carriage member to be moved to assume, for example, a position corresponding to that represented by the arrow 261 which will more readily sense a hand at a higher position. Similarly, in certain environments, it may be difficult to mount the dispenser other than at relatively high heights on a wall in which case a person using the dispenser may well be inclined to place their hand at a position farther below the discharge nozzle 34. In this case, placing the carriage member 220 into a position corresponding to that indicated by arrow 263 would facilitate a hand being sensed at a lower position underneath the discharge outlet.

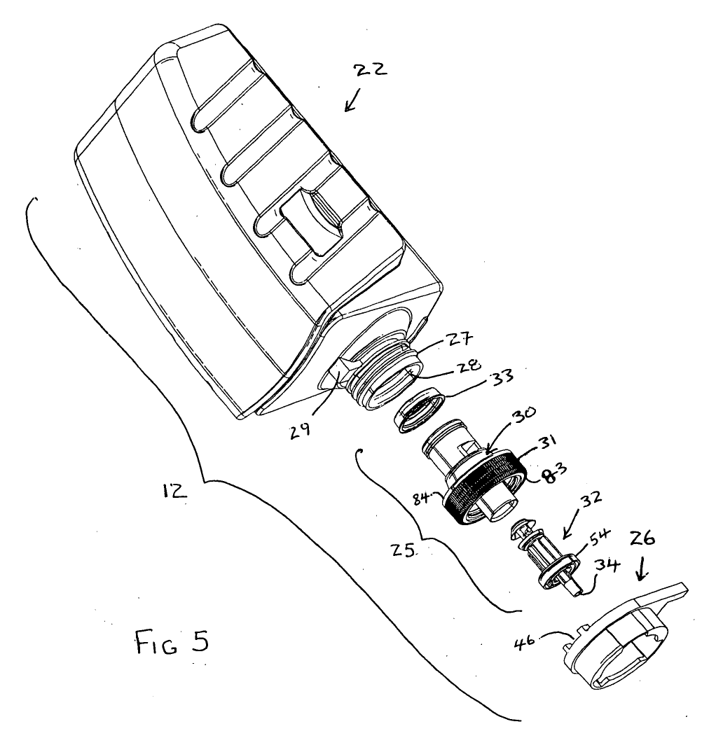

Referring to FIG. 5, it is generally preferred if the carriage member 220 is capable of being disposed such that the sensors 53 and 54 point virtually vertically downward or, preferably, no more than about ten degrees from the vertical. This is believed preferred to allow good sensing to ensure there is no dispensing before the hand is underneath the discharge outlet 34. However, insofar as there may be provided, for example, some surface such as a reflective countertop below the dispenser, then the difficulty arises that radiation from the emitter can bounce off the surface being reflected to the emitter and, thus, provide an false activation when there is no hand of a user under the discharge outlet 34. By adjusting the angle of the carriage member 220 to be increased, for example, to different angles such as 15 degrees or 20 degrees, or 25 degrees or 30 degrees or 35 degrees to the vertical or any angle in ranges therebetween, the difficulty with reflection as from a flat countertop surface can be reduced and typically eliminated. The present invention provides a convenient arrangement in which when a dispenser is installed on the wall, if there are problems with false readings as due to reflection, then the relative angle of the sensors altered to a vertical can be suitably directed.

It is believed that preferred angles for directing the sensors is in the range of 5 degrees to about 35 degrees, more preferably, in the range of about 10 degrees to about 30 degrees. In the preferred embodiment, the carriage member 220 is intended to be able to be located at angles of 10 degrees, 20 degrees and 30 degrees from the vertical. It is appreciated that a plurality of recesses may accommodate a plurality of different angles as may be desired.

It is not necessary that the point of coincidence be disposed at the hand or necessarily above or below the hand. For proper operation of the hand sensing device, it is merely necessary that radiation from the sensor 53 is adequately reflected from the hand so as to be received by the emitter 54. The pivotable carriage member 220 provides a simple mechanism for easy adjusting of the hand sensing system to optimally sense hands at different positions and locations relative to the dispenser, and/or to avoid problems with reflected radiation from permanent elements of the environment about the dispenser.

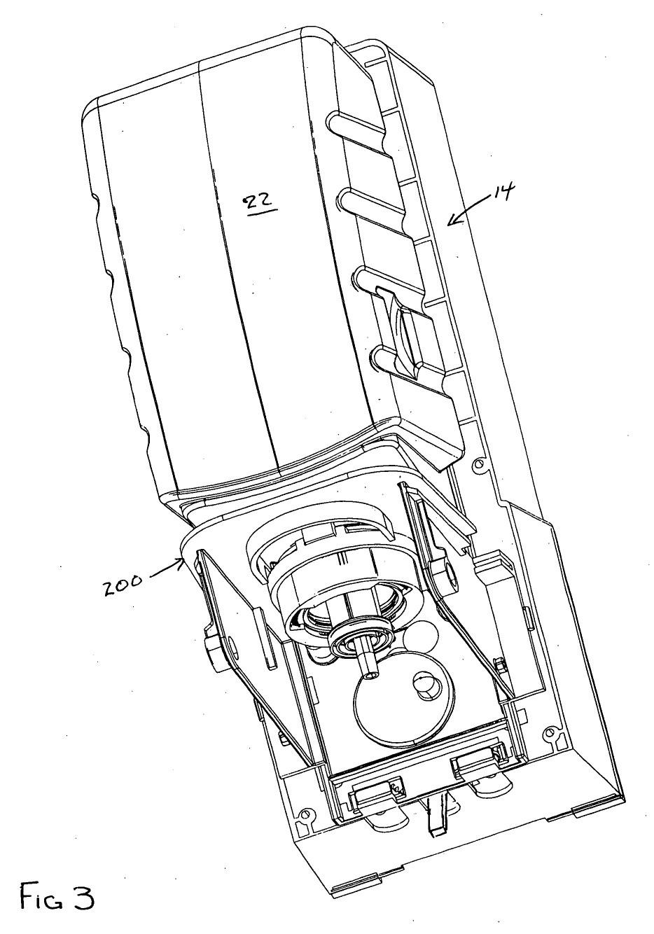

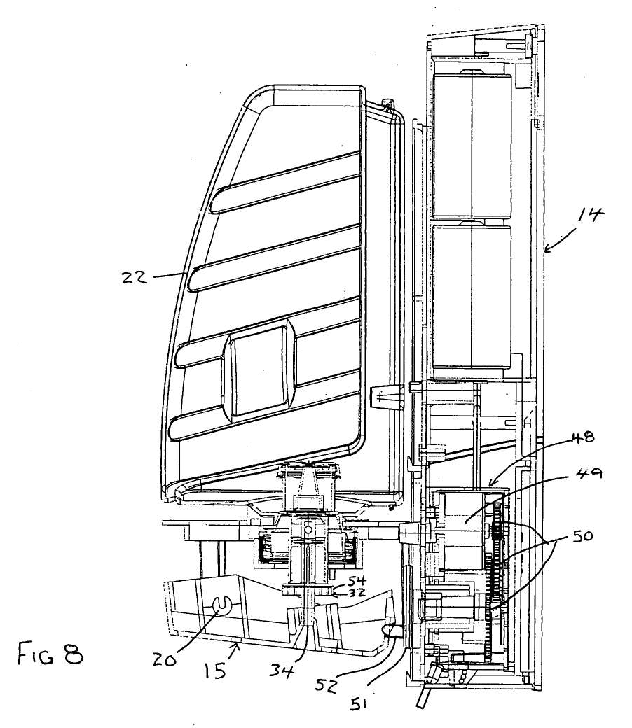

In the preferred embodiment as best shown in FIGS. 13 and 14, the handle member 240 a separate removable element from the carriage member 220 and not integrally formed as part of the carriage member 220. In this regard, the handle member 240 has an elongate portion 300 from which an elongate plug like key member 302 extends longitudinally at one end. The key member 302 has a rectangular cross sectional shape shaped and sized to fit inside a complementary rectangular key hole 304 in the carriage member 220 seen in FIG. 14. With the key member 302 engaged in the keyhole 304, the handle member 240 extends about a notional longitudinal 276 shown in FIG. 14 lying centered between the axis 253 and 254 all in the common plane. For ease of explanation of the invention the removable handle member 240 is shown coupled to the carriage member in each of FIGS. 1 to 4, 8 to 12 and 15 although in use in dispensing the handle member 240 should preferably be removed. The handle member 24 is not necessary and the handle member 240 could be eliminated and some other positioning mechanism may be provided for manual movement of the carriage member 220 or permitting access to the carriage member 220 as, for example, by use of a tool such as a screwdriver or the end of a cylindrical pencil. For example, with the handle member 240 could be removed and a flat head screwdriver could be inserted into the keyhole 304 in the support bar 238 as seen in FIG. 14.

Referring to FIG. 1 and FIG. 9, the backplate front housing 202 has three openings 281, 282 and 283 located in its lower wall 284 complementary to the locations of the sockets 225, handle 220 and socket 226, respectively. The openings 281 and 283 are disposed below the sockets 225 and 226 and are of a size to permit radiation from the emitter 53 to pass outwardly and radiation for the sensor 54 to pass inwardly in all desired rotational positions of the carriage member 220. Similarly, the opening 282 provides an opening through which the handle member 240 may extend for manual engagement and manipulation and permits the handle member 240 to assume any corresponding desired rotational positions of the carriage member 220. Insofar as the handle member 240 may be eliminated, then the central opening 282 may provide an access point for a tool to engage the carriage member 220.

The face plate 17 of the backplate housing 202 has an opening 285 through which the drive wheel 51 may extend for engagement with the gears 50 within the activation unit 48.

The face plate 17 also includes two openings 286 and 287 to receive two key shrouds 57 and 58 carried on the activation unit lid 212 and which are to receive a key emitter 55 and key sensor 56 of an optional key system as discussed hereafter.

In the preferred embodiment, engagement between the bosses on the catch arms and the recesses in the bridging member provide for discrete pre-set adjustment of the carriage member 220 to have the sensors at a plurality of different angles. It is to be appreciated that the device could be arranged to provide for the dispensing angle to be any desired angle within a range as, for example, by having the catch arms merely frictionally engage the sides of the retaining bridge.

In the preferred embodiments, the socket members 225 and 226 are shown as being fixed to the carriage member 220 against movement. This is preferred, however, it is to be appreciated that a carriage member could be further modified so as to provide an arrangement for changing the angle at which the socket members 225 and 226 converge towards each other, preferably, with the movement of the sockets being constrained to remain symmetrical relative to the pivot axis although this is not necessary.

### Reservoir Assembly

As best seen in FIG. 5, the reservoir assembly 12 comprises a reservoir bottle 22, a pump assembly 25 and a key collar 26. The bottle 22 has a threaded neck 27 about an outlet 28. A locking tab 29 extends forwardly and axially relative to the threaded neck 27 and is of generally rectangular shape in horizontal, axial cross-section having flat parallel side faces and an end face normal thereto. The pump assembly 25 includes a piston chamber forming member 30 having an outer flange 31 which is internally threaded such that the outer flange 31 may be threadably engaged onto the threaded neck 27. The pump assembly 25 further includes a piston 32 and a valve member 33. The piston 32 is reciprocally movable coaxially within a cylindrical chamber formed within the piston chamber forming member 30 so as to dispense fluid from inside the bottle 22 out of the outlet 28 internally through the piston 32 and out a discharge opening 34 of the outer end of the piston 32.

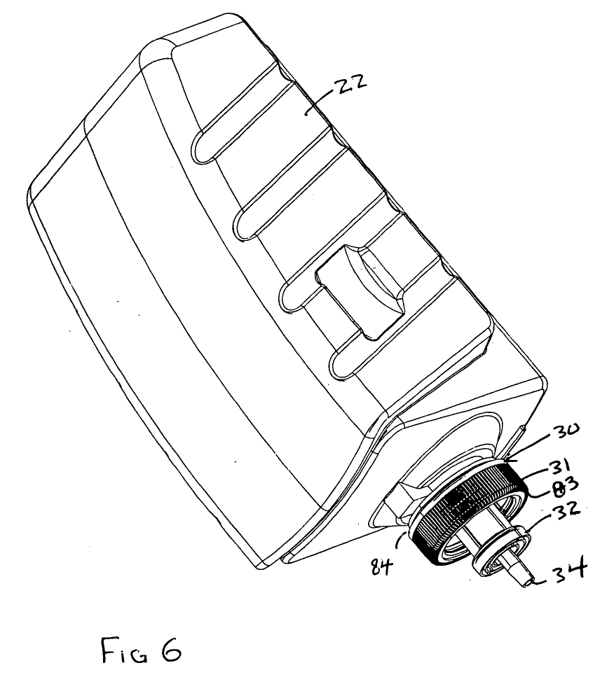

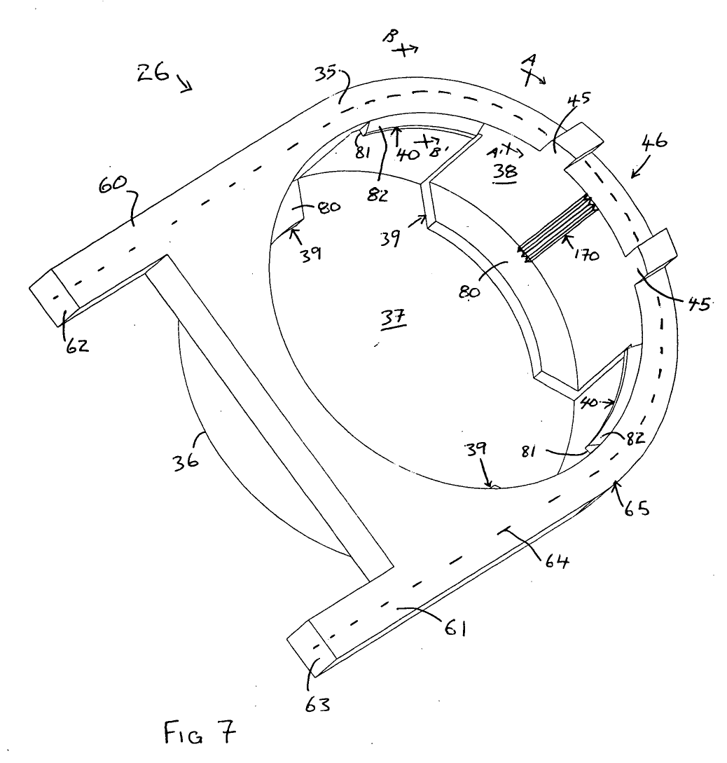

The bottle 22 and pump assembly 25 is shown assembled in FIG. 6. To the assembly as shown in FIG. 6, the key collar 26 is applied by sliding the collar 26 axially upwardly such that the collar 26 comes to be engaged in a snap-fit upon the outer flange 31 against removal from the outer flange 31 and with the locking tab 29 engaging in a slotway 46 on the collar 26 so as to prevent rotation of the collar 26 relative to the bottle 22. As seen in FIG. 7, the collar 26 has an axial upper end 35 and an axial lower end 36 with a central, generally cylindrical opening 37 extending therethrough. A generally cylindrical side wall 38 about the opening 37 carries approximate the lower end 36 three radially inwardly extending lower shoulder members 39 presenting stop shoulders 80 directed axially toward the upper end 35. Approximate the upper end 35, the side wall 38 includes three radially inwardly directed upper shoulder members 40. The upper shoulder members 40 have a catch surface 81 directed towards the lower end 36 and a bevelled camming surface 82 directed towards the upper end 35. On sliding of the collar 26 coaxially upwardly onto the outer flange 31, the camming surface 82 of the upper shoulder members 40 engage with an outer lower surface 83 of the outer flange 31 biasing the upper shoulder members 40 radially outwardly to permit the outer flange 31 to move relative the collar 26 axially toward the lower end 36 into the opening 37 of the collar 26. Once an upper end 84 of the outer flange 31 becomes located below the upper shoulder member 40, the upper shoulder member 40 returns to its inherent unbiased position with the catch surface 81 disposed above the upper end 84 of the outer flange 31 radially inwardly therefrom thus locking the outer flange 31 between the stop shoulders 80 of the lower shoulder member 39 and the catch surface 81 of the upper shoulder member 40.

The collar 26 carries on its upper end 35 a pair of upwardly extending lock tabs 45 providing a slotway 46 therebetween. The slotway 46 is sized to closely receive the locking tab 29 of the bottle 22 therebetween. When coupling the collar 26 onto the assembled bottle 22 and pump assembly 25, the slotway 46 is circumferentially aligned with the locking tab 29 on the bottle 22 such that the reservoir assembly 12 when fully assembled as shown in FIG. 2 has the locking tab 29 on the bottle 22 received within the slotway 46 preventing relative rotation of the collar 26 and bottle 12. In the reservoir assembly 12 as shown in FIG. 2, the piston chamber forming member 30 and the collar 26 are secured to the bottle 22 against removal. That is, the key collar 26 and piston chamber forming member 30 are preferably secured on the bottle 22 substantially against removal other than by significant breaking or deformation of the bottle 22 or key collar 26.

The extent to which removal or attempted removal of the collar 26 and/or pump assembly 25 is possible or is not possible, or may require destruction of one or more of the bottle 22, key collar 26 or piston chamber forming member 30 can be selected as desired. For example, at the time of assembly, the bottle 22, piston chamber forming member 30 and collar 26 can be permanently secured together as with glue or by sonic welding.

In a preferred embodiment, the interior side wall 38 of the collar 26 may be knurled with axially extending alternating ribs and slotways only partially shown at 170 in FIG. 7 such that a complementarily knurled outer surface of the outer flange 31 having axially extending alternating ribs and slotways may couple with ribs on the side wall 38 preventing relative rotation of the piston chamber forming member 30 relative to the collar 26 once the collar is applied.

With the backplate assembly 14, presser member 15 and shroud 16 assembled and, for example, secured to a wall, the assembled reservoir assembly 12 may be coupled thereto by the reservoir assembly 12 moving vertically downwardly relative the backplate assembly 14 with the collar member 26 and pump assembly 25 to pass vertically downwardly through an opening 190 in the plate 18, and the entire reservoir assembly 12 then being urged rearwardly to engage a rear support portion 191 of the plate 18 above the collar 26 and below a lower shoulder 192 on the bottle placing the piston 32 into a position for coupling with or in which it is coupled with the presser member 15. Removal of the reservoir assembly 12 is accomplished by reversed movement forwardly then upwardly.

The presser member 15 is coupled to the piston 32 by engagement between catch members (not shown) carried by the presser member 15 with an engagement flange 54 on the piston 32. Such catch members and engagement may be similar to that described in U.S. Pat. No. 5,373,970 to Ophardt dated Dec. 20, 1994, the disclosure of which is incorporated herein by reference, which engagement necessarily results on coupling of the reservoir assembly 12 with the backplate assembly 14.

### Optical Key System

The activation unit 48 is shown to also includes portions of an optional optical key system for determining if the reservoir assembly 12 is compatible with the activation unit 48, that is, whether the reservoir assembly 12 meets pre-selected criteria to permit use with the activation unit 48. The circuit board 216 of the activation unit 48 includes an electromagnetic radiation key emitter 55 and an electromagnetic radiation key sensor 56. The lid 21 of the activation unit 48 includes on an upper portion of its front face a pair of hollow shrouds 57 and 58 which are directed forwardly. The key emitter 55 is received in the generally cylindrical shroud 57 about a lamp of the key emitter 55 and the key sensor 56 is received in the generally cylindrical shroud 57 about a lamp of the key emitter. The shrouds 57 and 58 substantially prevent any transmission of electromagnetic radiation therethrough and effectively serve to directionalize the key emitter 55 and key sensor 56 so as to restrict emissions or receptions of either to light passing through the outer end of the shrouds 57 and 58. As best seen in FIGS. 4 and 7, the collar 26 has two arms 60 and 61 which extend rearwardly from the collar 26 toward each of the key emitter 55 and key sensor 57. The collar 26 provides an electromagnetic radiation wave guide from an end face 62 at the end of arm 60 through the collar 26 to the face 63 at the end of the arm 61 providing an outlet to the wave guide. The wave guide is schematically illustrated in dashed lines as 64 in FIG. 7 as extending in a generally U-shape within a U-shaped rim 65 of material disposed proximate the upper end 35 of the collar 26 about its outer periphery.

Referring to FIG. 4, electromagnetic radiation emitted by the key emitter 55 enters the wave guide 64 via the inlet end face 62 and is conducted via the wave guide 64 through the collar 26 with electromagnetic radiation to exit the wave guide 64 via the outlet end face 63 with the radiation exiting the wave guide via the outlet end face 63 to be sensed by the key sensor 56. The activation unit 48 includes a key control system under which as a prerequisite to dispensing, having regard to the electromagnetic radiation emitted by the key emitter 55, the electromagnetic radiation sensed by the key sensor 56 is to comply with one or more pre-selected parameters. As by way of a non-limiting example, the key emitter 55 may emit electromagnetic radiation within a selected range of wave lengths and, in the absence of the key sensor 56 sensing electromagnetic radiation within the range of emitted radiation, the motor 49 may not be permitted to operate. Thus, in the simplest case, should a non-compliant reservoir assembly 12 which has the bottle 22, pump assembly 25 but not the collar 26, be coupled to the backplate assembly 14 and would not have a wave guide, the radiation of a selected wavelength emitted by key emitter 55 would not be directed to or sensed by the key sensor 56 and the control mechanism of the activation unit would not permit dispensing.

In the preferred embodiment, the collar 26 may preferably be formed as by injection molding from a plastic material which permits transmission of electromagnetic radiation therethrough. As is known to a person skilled in the art, various plastic materials such as polycarbonate plastics can be used which provide a resultant product having electromagnetic radiation transmitting properties. Radiation which may enter the light transmitting collar 26 as by being directed normal to the inlet end face 62 will, to some extent, be reflected internally by reason of such light impinging at relatively low angles on the external surfaces of the collar forming effectively the sides of the wave guide. A portion of the radiation directed into the collar 26 is passed through the collar 26 as around the U-shaped external rim 65 with some proportion of the radiation to be directed substantially perpendicular to the exit end face 63 to exit the wave guide and be sensed by the key sensor 56.

The collar 26 may be formed as unitary element all from the same radiation transmitting properties or may be formed from a number of different materials. For example, to increase internal reflection, exterior surfaces of the collar 26 especially about the rim 65 could be coated with a reflective material other than on the inlet end face 62 and the outlet end face 63. The collar 26 may be formed such that merely a U-shaped portion of the collar, for example, substantially corresponding to the U-shaped rim 65 may comprise light transmitting materials and the remainder of the collar may be formed of other plastic materials.

The collar 26 may be formed to incorporate therein one or more pre-existing optical fibres, for example, disposed to extend internally within the U-shaped rim as with an inlet end of an optical fibre to be presented at the inlet end face 62 and an outlet end of the optical fibre to be presented at an outlet end face 63.

In accordance with the present invention, the electromagnetic radiation for the key emitter may be selected having regard to pre-selected parameters. These parameters may include radiation within one or more ranges of wavelengths, electromagnetic radiation within one or more ranges of intensity, polarized electromagnetic radiation, and electromagnetic radiation within one or more ranges of duration and at one or more different points in time.

The wave guide which is provided may have electromagnetic radiation transmitted properties selected from a plurality of properties and including the ability to transmit one or more ranges of wavelengths and or the ability to block one or more ranges of wavelengths, the ability to restrict the intensity of electromagnetic radiation which can be transmitted through the wave guide, preferably, as a function of most of the wave guide. The transmission properties may restrict the transmission of radiation having a first range of wavelengths yet permit transmission of radiation having a range of second wavelengths.

As to the nature of electromagnetic radiation to be used, many conventionally available sensors and/or emitters are available for use in emitting and sensing electromagnetic radiation in the visible light spectrum. This is not necessary, however, and electromagnetic radiation outside the visible spectrum may be used. This could be advantageous as, for example, to mask the nature of any modular components which may comprise a portion of a wave guide. For example, whether or not any modular wave guide element may appear to have a visible colour such as blue, red or yellow, insofar as it is adapted for transmission of non-visible electromagnetic radiation, then the presence or absence of colour in the modular unit could assist in fooling an imitator.

In accordance with the preferred embodiment, a circuit board 216 is provided plus simplified carrying of electronics and ease of electrical coupling of the motor 49, the hand sensing system components including the sensor 53 and the emitter 54 and the optional key system including the key emitter 55 and the key sensor 57. In accordance with the present invention, it is not necessary that a key system be provided and thus would be appreciated that in this case the dispenser could be provided without the key emitter 55 or key sensor 56 or their shrouds and without the collar 26. The embodiment disclosed would function with the elimination of these elements and, for example, with the reservoir assembly to be inserted comprising that merely shown in FIG. 6.

While the invention has been described with reference to preferred embodiments, many modifications and variations will now occur to persons skilled in the art. For a definition of the invention, reference is made to the following claims.

We claim:

1. An automatic dispensing apparatus for dispensing material onto a hand of a user when the hand is suitable positioned under a dispensing outlet for the material to be dispensed, the dispenser having an emitter to emit electromagnetic radiation and a sensor to sense electromagnetic radiation emitted by the emitter which is reflected off a user hand suitably positioned under the outlet,
the improvement comprising a carriage member mounted to the apparatus for relative pivoting about a pivot axis,
the emitter and sensor carried by carriage member,
the emitter being generally directional emitting radiation to emanate outwardly from the emitter generally along a longitudinal emission axis,
the sensor being generally directional and sensing radiation which emanates generally along a longitudinal sensing axis terminating in the sensor,
the emission axis and the sensing axis generally disposed in a common plane which includes the horizontal axis.

2. A dispensing apparatus as claimed in claim 1 wherein the pivot axis is horizontal.

3. A dispensing apparatus as claimed in claim 1 wherein the emission axis and the sensing axis converge to intersect at a convergence point in the plane below the dispenser.

4. A dispensing apparatus as claimed in claim 2 wherein the emitter and sensor are spaced from each other in a direction measured parallel to the axis.

5. A dispensing apparatus as claimed in claim 3 wherein the emitter and sensor are spaced from each other in a direction measured parallel to the axis.

6. A dispensing apparatus as claimed in claim 1 wherein the emission axis is at a fixed emitter angle relative to the pivot axis and the sensing axis is at a fixed sensing angle relative to the pivot axis, the sensing angle is equal to the emitter angle.

7. A dispensing apparatus as claimed in claim 1 wherein the carriage member mounted to the apparatus for pivoting about the pivot axis between a plurality of different positions.

8. A dispensing apparatus as claimed in claim 1 wherein the dispenser has a backplate for mounting as to a vertical wall and protrudes forwardly from the backplate with the dispensing outlet dispensing material downwardly spaced forwardly from the backplate,
wherein pivoting the carriage member places the common plane at different angular orientations relative to a vertical.

9. A dispensing apparatus as claimed in claim 1 wherein a dispensing axis extends downwardly from the dispensing outlet,
pivoting the carriage member locates an intersection of the dispensing axis with the common plane at different relative heights below the dispensing outlet.

10. A dispensing apparatus as claimed in claim 1 wherein the dispenser has the carriage mounted at an under side of the dispenser to direct the plane downwardly and forwardly with the common plane to intersect with a user's hand when positioned at a selected position.

11. A dispensing apparatus as claimed in claim 1 including an angular positioning mechanism to releasably lock the carriage member at a different angular positions relative the pivot axis.

12. A dispensing apparatus as claimed in claim 11 including a positioning member rearwardly coupled to the carriage and manually engagable by a user to pivot the carriage member to different angular positions relative the pivot axis.

13. A dispensing apparatus as claimed in claim 12 wherein the positioning member comprises a lever member when coupled to the carriage projects from the carriage member radially relative the pivot axis for manual engagement under the dispensing apparatus.

14. A dispensing apparatus as claimed in claim 1 wherein further comprising:
a reservoir assembly including a reservoir containing material to be dispensed, an activation unit, and a pump mechanism activatable by the activation unit to dispense material from the reservoir out of the outlet opening,
a control mechanism to permit operation of the dispenser when the sensor senses radiation from the emitter.

15. A dispensing apparatus as claimed in claim 14 wherein the reservoir assembly removably coupled to the activation unit for replacement by a similar reservoir assembly,
an electromagnetic radiation wave guide having an inlet and an outlet and providing a path for transmission of electromagnetic radiation from the inlet to the outlet,
an electromagnetic radiation sensing element carried by the activation unit sensing electromagnetic radiation from the wave guide via the outlet,
an electromagnetic radiation emitting element carried by the activation unit directing electromagnetic radiation into the wave guide via the inlet,
at least part of the wave guide carried by the reservoir assembly and removable therewith,
the control mechanism to permit operation of the dispenser only when the electromagnetic radiation sensed by the sensing element appropriately correlates to a pre-selected electromagnetic radiation profile emitted by the emitting element.

16. A dispensing system as claimed in claim 15 wherein the reservoir having an outlet opening for dispensing of material therefrom,
an outlet member secured to the outlet substantially against removal from the reservoir,
the outlet member when secured to the reservoir rendering the reservoir difficult to refill with material through the outlet.

17. A dispensing system as claimed in claim 16 wherein the reservoir having an outlet opening for dispensing of material therefrom,
an outlet member secured to the outlet substantially against removal from the reservoir,
removal of the outlet member causing destruction of a portion of the wave guide which changes transmission characteristics of electromagnetic radiation from the inlet to the outlet via the path,
the reservoir aside from the outlet opening not having another opening via which material may be passed except with difficulty to refill the reservoir with material,
the outlet member includes a collar member coupling to the reservoir about the outlet opening and securing the pump mechanism to the reservoir against removal without removal of the collar member,
the collar member secured to the outlet substantially against removal from the reservoir.
